(19) United States
(12) Patent Application Publication
(10) Pub. No.: US 2021/0099502 A1
(43) Pub. Date: Apr. 1, 2021

(54) CONTENT ITEM SHARING WITH CONTEXT

(71) Applicant: Dropbox, Inc., San Francisco, CA (US)

(72) Inventors: Benjamin Stern, San Francisco, CA (US); Iris Lin, San Francisco, CA (US); Royce Ausburn, Mountain View, CA (US); Nicholas Larson, San Francisco, CA (US); Derrick Ho, Palo Alto, CA (US); Amanda Gail Miller, San Francisco, CA (US); Harshad Kulkarni, Dublin, CA (US); Charlotte Ziob, Oakland, CA (US)

(21) Appl. No.: 16/587,441

(22) Filed: Sep. 30, 2019

(51) Int. Cl. H04L 29/06; H04L 29/08; H04L 12/58

(52) U.S. Cl. CPC H04L 65/403; H04L 67/306; H04L 67/20; G06Q 50/184; H04L 51/24; H04L 51/22; H04L 51/04

(57) ABSTRACT

The present technology provides a system wherein context provided in a message in which a content item is shared is preserved in a database that is linked to the content item. Additionally, to help users that are sending a content item provide better context when they are sharing a content item, the present technology provides a sharing user interface that encourages the first user to provide helpful context. Additionally, the present technology provides a sharing interface that can present shared content items along with the context in which the content item was shared.

### TECHNICAL FIELD

The present technology generally pertains to sharing a content item with a message that gives context to the sharing, and more specifically pertains to an interface for sharing a content item as well as an interface for viewing shared content items that associate the context of the sharing with representations of the content item.

### BACKGROUND

There are several services that are useful for sharing a content item with a message that provides some context to why the content item is being shared. For example, a first user account can send an email to a target user account that includes a content item and a message. In another example, a first user account can send a message using a messaging service (like instant messaging) or a team based communication service (like SLACK or WEBEX TEAMS) that can include a content item and a message pertaining to why the content item is being shared. In another example, a first user can assign tasks in a workflow service and send a content item along with the task.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example of a content management system and client devices in accordance with some aspects of the present technology;

FIG. 2 shows an example embodiment of a sharing modal in accordance with some aspects of the present technology;

FIG. 3 shows an example embodiment of a sharing interface in accordance with some aspects of the present technology;

FIG. 4 shows an example embodiment of a sharing interface in accordance with some aspects of the present technology;

FIG. 5 shows an example method embodiment for receiving a sharing request with sharing context;

FIG. 6 shows an example method embodiment for presenting a sharing request with sharing context; and

FIG. 7 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology addresses the need in the art for interfaces that can enhance the context associated with a shared content item, and for a system that can store context associated with the shared content item in way that is linked to the content item outside of the original communication that shared the content item. Many users receive many content items through various sharing services and applications, and while the initial communication might include some amount of content, as soon as the content item is saved to a location where the content item can be edited, or stored for retrieval in the future, the context becomes separated from the content item.

There are several services that are useful for sharing a content item with a message providing some context to why the content item is being shared. For example, a first user account can send an email to a target user account that includes a content item and a message. In another example, a first user account can send a message using a messaging service (like instant messaging) or a team based communication service (like SLACK or WEBEX TEAMS) that can include a content item and a message pertaining to why the content item is being shared. In another example, a first user can assign tasks in a workflow service and send a content item along with the task. In each of these examples the context associated with the sharing remains fixed in the communication in which the sharing occurred.

In order to view the context associated with the content item in the above systems, the target user needs to remember which service or application was used to share the content item, and find the communication in which the content item was shared. This is not a workable solution for users that utilize multiple sharing services and receive content items shared from many different sources and teams.

The present technology provides a system wherein context provided in a message in which a content item is shared is preserved in a database that is linked to the content item. When the content item is viewed any context associated with the content item in the database can be presented along with the content item. Additionally, to help users that are sending a content item to provide better context when they are sharing a content item, the present technology provides a sharing user interface that encourages users to provide helpful context. Additionally, the present technology provides a sharing interface that can present all shared content items along with the context in which the content item was shared.

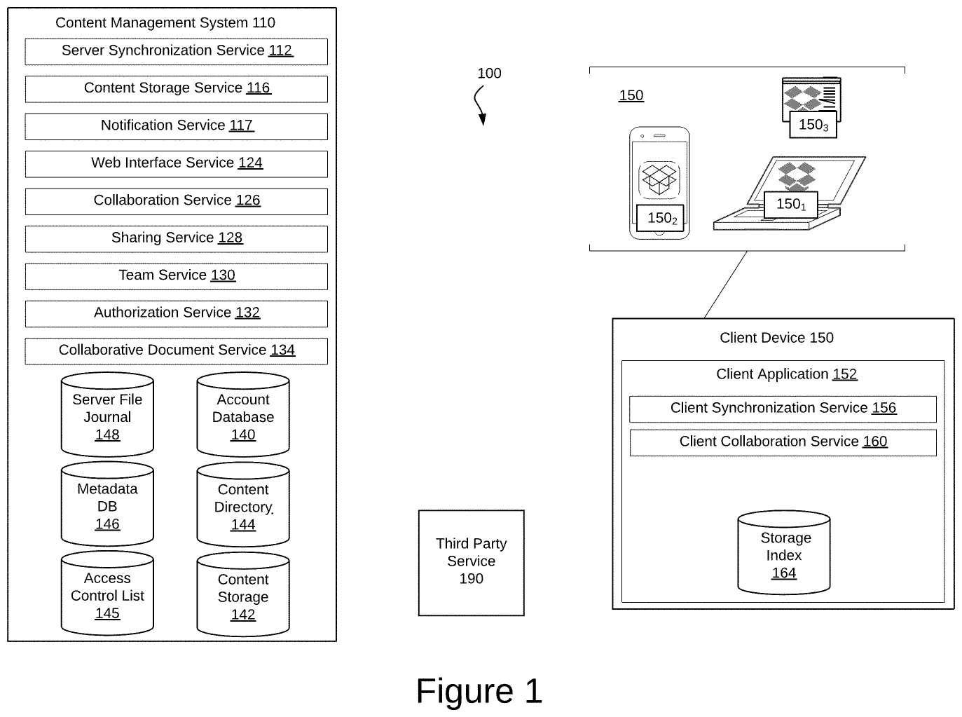

In some embodiments, the disclosed technology is deployed in the context of a content management system having content item synchronization capabilities and collaboration features, among others. An example system configuration 100 is shown in FIG. 1, which depicts content management system 110 interacting with client device 150.

Accounts

Content management system 110 can store content items in association with accounts, as well as perform a variety of content item management tasks, such as retrieve, modify, browse, and/or share the content item(s). Furthermore, content management system 110 can enable an account to access content item(s) from multiple client devices.

Content management system 110 supports a plurality of accounts. An entity (user, group of users, team, company, etc.) can create an account with content management system, and account details can be stored in account database 140. Account database 140 can store profile information for registered entities. In some cases, profile information for registered entities includes a username and/or email address. Account database 140 can include account management information, such as account type (e.g. various tiers of free or paid accounts), storage space allocated, storage space used, client devices 150 having a registered content management client application 152 resident thereon, security settings, personal configuration settings, etc.

Account database 140 can store groups of accounts associated with an entity. Groups can have permissions based on group policies and/or access control lists, and members of the groups can inherit the permissions. For example, a marketing group can have access to one set of content items while an engineering group can have access to another set of content items. An administrator group can modify groups, modify user accounts, etc.

Content Item Storage

A feature of content management system 110 is the storage of content items, which can be stored in content storage 142. Content items can be any digital data such as documents, collaboration content items, text files, audio files, image files, video files, webpages, executable files, binary files, etc. A content item can also include collections or other mechanisms for grouping content items together with different behaviors, such as folders, zip files, playlists, albums, etc. A collection can refer to a folder, or a plurality of content items that are related or grouped by a common attribute. In some embodiments, content storage 142 is combined with other types of storage or databases to handle specific functions. Content storage 142 can store content items, while metadata regarding the content items can be stored in metadata database 146. Likewise, data regarding where a content item is stored in content storage 142 can be stored in content directory 144. Additionally, data regarding changes, access, etc. can be stored in server file journal 148. Each of the various storages/databases such as content storage 142, content directory 144, server file journal 148, and metadata database 146 can be comprised of more than one such storage or database and can be distributed over many devices and locations. Other configurations are also possible. For example, data from content storage 142, content directory 144, server file journal 148, and/or metadata database 146 may be combined into one or more content storages or databases or further segmented into additional content storages or databases. Thus, content management system 110 may include more or less storages and/or databases than shown in FIG. 1.

In some embodiments, content storage 142 is associated with at least one content storage service 116, which includes software or other processor executable instructions for managing the storage of content items including, but not limited to, receiving content items for storage, preparing content items for storage, selecting a storage location for the content item, retrieving content items from storage, etc. In some embodiments, content storage service 116 can divide a content item into smaller chunks for storage at content storage 142. The location of each chunk making up a content item can be recorded in content directory 144. Content directory 144 can include a content entry for each content item stored in content storage 142. The content entry can be associated with a unique ID, which identifies a content item.

In some embodiments, the unique ID, which identifies a content item in content directory 144, can be derived from a deterministic hash function. This method of deriving a unique ID for a content item can ensure that content item duplicates are recognized as such since the deterministic hash function will output the same identifier for every copy of the same content item, but will output a different identifier for a different content item. Using this methodology, content storage service 116 can output a unique ID for each content item.

Content storage service 116 can also designate or record a content path for a content item in metadata database 146. The content path can include the name of the content item and/or folder hierarchy associated with the content item. For example, the content path can include a folder or path of folders in which the content item is stored in a local file system on a client device. While content items are stored in content storage 142 in blocks and may not be stored under a tree like directory structure, such directory structure is a comfortable navigation structure for users. Content storage service 116 can define or record a content path for a content item wherein the “root” node of a directory structure can be a namespace for each account. Within the namespace can be a directory structure defined by a user of an account and/or content storage service 116. Metadata database 146 can store the content path for each content item as part of a content entry.

In some embodiments, the namespace can include additional namespaces nested in the directory structure as if they are stored within the root node. This can occur when an account has access to a shared collection. Shared collections can be assigned their own namespace within content management system 110. While some shared collections are actually a root node for the shared collection, they are located subordinate to the account namespace in the directory structure, and can appear as a folder within a folder for the account. As addressed above, the directory structure is merely a comfortable navigation structure for users, but does not correlate to storage locations of content items in content storage 142.

While the directory structure in which an account views content items does not correlate to storage locations at content management system 110, the directory structure can correlate to storage locations on client device 150 depending on the file system used by client device 150.

As addressed above, a content entry in content directory 144 can also include the location of each chunk making up a content item. More specifically, the content entry can include content pointers that identify the location in content storage 142 of the chunks that make up the content item.

In addition to a content path and content pointer, a content entry in content directory 144 can also include a user account identifier that identifies the user account that has access to the content item and/or a group identifier that identifies a group with access to the content item and/or a namespace to which the content entry belongs.

Content storage service 116 can decrease the amount of storage space required by identifying duplicate content items or duplicate blocks that make up a content item or versions of a content item. Instead of storing multiple copies, content storage 142 can store a single copy of the content item or block of the content item and content directory 144 can include a pointer or other mechanism to link the duplicates to the single copy.

Content storage service 116 can also store metadata describing content items, content item types, folders, file path, and/or the relationship of content items to various accounts, collections, or groups in metadata database 146, in association with the unique ID of the content item.

Content storage service 116 can also store a log of data regarding changes, access, etc. in server file journal 148. Server file journal 148 can include the unique ID of the content item and a description of the change or access action along with a time stamp or version number and any other relevant data. Server file journal 148 can also include pointers to blocks affected by the change or content item access. Content storage service can provide the ability to undo operations, by using a content item version control that tracks changes to content items, different versions of content items (including diverging version trees), and a change history that can be acquired from the server file journal 148.

Content Item Synchronization

Another feature of content management system 110 is synchronization of content items with at least one client device 150. Client device(s) can take different forms and have different capabilities. For example, client device 150₁ is a computing device having a local file system accessible by multiple applications resident thereon. Client device 150₂ is a computing device wherein content items are only accessible to a specific application or by permission given by the specific application, and the content items are typically stored either in an application specific space or in the cloud. Client device 150₃ is any client device accessing content management system 110 via a web browser and accessing content items via a web interface. While example client devices 150₁, 150₂, and 150₃ are depicted in form factors such as a laptop, mobile device, or web browser, it should be understood that the descriptions thereof are not limited to devices of these example form factors. For example a mobile device such as client 150₂ might have a local file system accessible by multiple applications resident thereon, or client 150₂ might access content management system 110 via a web browser. As such, the form factor should not be considered limiting when considering client 150's capabilities. One or more functions described herein with respect to client device 150 may or may not be available on every client device depending on the specific capabilities of the device—the file access model being one such capability.

In many embodiments, client devices are associated with an account of content management system 110, but in some embodiments client devices can access content using shared links and do not require an account.

As noted above, some client devices can access content management system 110 using a web browser. However, client devices can also access content management system 110 using client application 152 stored and running on client device 150. Client application 152 can include a client synchronization service 156.

Client synchronization service 156 can be in communication with server synchronization service 112 to synchronize changes to content items between client device 150 and content management system 110.

Client device 150 can synchronize content with content management system 110 via client synchronization service 156. The synchronization can be platform agnostic. That is, content can be synchronized across multiple client devices of varying type, capabilities, operating systems, etc. Client synchronization service 156 can synchronize any changes (new, deleted, modified, copied, or moved content items) to content items in a designated location of a file system of client device 150.

Content items can be synchronized from client device 150 to content management system 110, and vice versa. In embodiments wherein synchronization is from client device 150 to content management system 110, a user can manipulate content items directly from the file system of client device 150, while client synchronization service 156 can monitor directory on client device 150 for changes to files within the monitored folders.

When client synchronization service 156 detects a write, move, copy, or delete of content in a directory that it monitors, client synchronization service 156 can synchronize the changes to content management storage service 116. In some embodiments, client synchronization service 156 can perform some functions of content management storage service 116 including functions addressed above such as dividing the content item into blocks, hashing the content item to generate a unique identifier, etc. Client synchronization service 156 can index content within client storage index 164 and save the result in storage index 164. Indexing can include storing paths plus a unique server identifier, and a unique client identifier for each content item. In some embodiments, client synchronization service 156 learns the unique server identifier from server synchronization service 112, and learns the unique client identifier from the operating system of client device 150.

Client synchronization service 156 can use storage index 164 to facilitate the synchronization of at least a portion of the content within client storage with content associated with a user account on content management system 110. For example, client synchronization service 156 can compare storage index 164 with content management system 110 and detect differences between content on client storage and content associated with a user account on content management system 110. Client synchronization service 156 can then attempt to reconcile differences by uploading, downloading, modifying, and deleting content on client storage as appropriate. Content storage service 116 can store the changed or new block for the content item and update server file journal 148, metadata database 146, content directory 144, content storage 142, account database 140, etc. as appropriate.

When synchronizing from content management system 110 to client device 150, a mount, modification, addition, deletion, move of a content item recorded in server file journal 148 can trigger a notification to be sent to client device 150 using notification service 117. When client device 150 is informed of the change a request changes listed in server file journal 148 since the last synchronization point known to the client device. When client device 150 determines that it is out of synchronization with content management system 110, client synchronization service 156 requests content item blocks including the changes, and updates its local copy of the changed content items.

In some embodiments, storage index 164 stores tree data structures wherein one tree reflects the latest representation of a directory according to server synchronization service 112, while another tree reflects the latest representation of the directory according to client synchronization service 156. Client synchronization service can work to ensure that the tree structures match by requesting data from server synchronization service 112 or committing changes on client device 150 to content management system 110.

Sometimes client device 150 might not have a network connection available. In this scenario, client synchronization service 156 can monitor the linked collection for content item changes and queue those changes for later synchronization to content management system 110 when a network connection is available. Similarly, a user can manually start, stop, pause, or resume synchronization with content management system 110.

Client synchronization service 156 can synchronize all content associated with a particular user account on content management system 110. Alternatively, client synchronization service 156 can selectively synchronize a portion of the content of the total content associated with the particular user account on content management system 110. Selectively synchronizing only a portion of the content can preserve space on client device 150 and save bandwidth.

In some embodiments, client synchronization service 156 selectively stores a portion of the content associated with the particular user account and stores placeholder content items in client storage for the remainder portion of the content. For example, client synchronization service 156 can store a placeholder content item that has the same filename, path, extension, metadata, of its respective complete content item on content management system 110, but lacking the data of the complete content item. The placeholder content item can be a few bytes or less in size while the respective complete content item might be significantly larger. After client device 150 attempts to access the content item, client synchronization service 156 can retrieve the data of the content item from content management system 110 and provide the complete content item to accessing client device 150. This approach can provide significant space and bandwidth savings while still providing full access to a user's content on content management system 110.

Collaboration Features

Another feature of content management system 110 is to facilitate collaboration between users. Collaboration features include content item sharing, commenting on content items, co-working on content items, instant messaging, providing presence and seen state information regarding content items, etc.

Sharing

Content management system 110 can manage sharing content via sharing service 128. Sharing content by providing a link to the content can include making the content item accessible from any computing device in network communication with content management system 110. However, in some embodiments a link can be associated with access restrictions enforced by content management system 110 and access control list 145. Sharing content can also include linking content using sharing service 128 to share content within content management system 110 with at least one additional user account (in addition to the original user account associated with the content item) so that each user account has access to the content item. The additional user account can gain access to the content by accepting the content, which will then be accessible through either web interface service 124 or directly from within the directory structure associated with their account on client device 150. The sharing can be performed in a platform agnostic manner. That is, the content can be shared across multiple client devices 150 of varying type, capabilities, operating systems, etc. The content can also be shared across varying types of user accounts.

To share a content item within content management system 110 sharing service 128 can add a user account identifier or multiple user account identifiers to a content entry in access control list database 145 associated with the content item, thus granting the added user account access to the content item. Sharing service 128 can also remove user account identifiers from a content entry to restrict a user account's access to the content item. Sharing service 128 can record content item identifiers, user account identifiers given access to a content item, and access levels in access control list database 145. For example, in some embodiments, user account identifiers associated with a single content entry can specify different permissions for respective user account identifiers with respect to the associated content item.

To share content items outside of content management system 110, sharing service 128 can generate a custom network address, such as a uniform resource locator (URL), which allows any web browser to access the content item or collection in content management system 110 without any authentication. To accomplish this, sharing service 128 can include content identification data in the generated URL, which can later be used to properly identify and return the requested content item. For example, sharing service 128 can include the account identifier and the content path or a content item identifying code in the generated URL. Upon selection of the URL, the content identification data included in the URL can be transmitted to content management system 110, which can use the received content identification data to identify the appropriate content item and return the content item.

In addition to generating the URL, sharing service 128 can also be configured to record in access control list database 145 that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing service 128 can change the value of the flag to 1 or true after generating a URL to the content item.

In some embodiments, sharing service 128 can associate a set of permissions to a URL for a content item. For example, if a user attempts to access the content item via the URL, sharing service 128 can provide a limited set of permissions for the content item. Examples of limited permissions include restrictions that the user cannot download the content item, save the content item, copy the content item, modify the content item, etc. In some embodiments, limited permissions include restrictions that only permit a content item to be accessed from with a specified domain, i.e., from within a corporate network domain, or by accounts associated with a specified domain, e.g., accounts associated with a company account (e.g., @acme.com).

In some embodiments, sharing service 128 can also be configured to deactivate a generated URL. For example, each content entry can also include a URL active flag indicating whether the content should be returned in response to a request from the generated URL. For example, sharing service 128 can only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing service 128 can reactivate the URL by again changing the value of the URL active flag to 1 or true. A user can thus easily restore access to the content item without the need to generate a new URL.

In some embodiments, content management system 110 can designate a URL for uploading a content item. For example, a first user with a user account can request such a URL, provide the URL to a contributing user and the contributing user can upload a content item to the first user's user account using the URL.

Team Service

In some embodiments, content management system 110 includes team service 130. Team service 130 can provide functionality for creating and managing defined teams of user accounts. Teams can be created for a company, with sub-teams (e.g., business units, or project teams, etc.), and user accounts assigned to teams and sub-teams, or teams can be created for any defined group of user accounts. Teams service 130 can provide a common shared space for the team, private user account folders, and access limited shared folders. Teams service can also provide a management interface for an administrator to manage collections and content items within team, and can manage user accounts that are associated with the team.

Authorization Service

In some embodiments, content management system 110 includes authorization service 132. Authorization service 132 ensures that a user account attempting to access a namespace has appropriate rights to access the namespace. Authorization service 132 can receive a token from client application 152 that follows a request to access a namespace and can return the capabilities permitted to the user account. For user accounts with multiple levels of access (e.g. a user account with user rights and administrator rights) authorization service 132 can also require explicit privilege escalation to avoid unintentional actions by administrators.

Presence and Seen State

In some embodiments, content management system can provide information about how users with which a content item is shared are interacting or have interacted with the content item. In some embodiments, content management system 110 can report that a user with which a content item is shared is currently viewing the content item. For example, client collaboration service 160 can notify notifications service 117 when client device 150 is accessing the content item. Notifications service 117 can then notify all client devices of other users having access to the same content item of the presence of the user of client device 150 with respect to the content item.

In some embodiments, content management system 110 can report a history of user interaction with a shared content item. Collaboration service 126 can query data sources such as metadata database 146 and server file journal 148 to determine that a user has saved the content item, that a user has yet to view the content item, etc., and disseminate this status information using notification service 117 to other users so that they can know who currently is or has viewed or modified the content item.

Collaboration service 126 can facilitate comments associated with content, even if a content item does not natively support commenting functionality. Such comments can be stored in metadata database 146.

Collaboration service 126 can originate and transmit notifications for users. For example, a user can mention another user in a comment and collaboration service 126 can send a notification to that user that he has been mentioned in the comment. Various other content item events can trigger notifications, including deleting a content item, sharing a content item, etc.

Collaboration service 126 can provide a messaging platform whereby users can send and receive instant messages, voice calls, emails, etc.

Collaboration Content Items

In some embodiments, content management service can also include Collaborative document service 134 which can provide an interactive content item collaboration platform whereby users can simultaneously create collaboration content items, comment in the collaboration content items, and manage tasks within the collaboration content items. Collaboration content items can be files that users can create and edit using a collaboration content item editor, and can contain collaboration content item elements. Collaboration content item elements may include a collaboration content item identifier, one or more author identifiers, collaboration content item text, collaboration content item attributes, interaction information, comments, sharing users, etc. Collaboration content item elements can be stored as database entities, which allows for searching and retrieving the collaboration content items. Multiple users may access, view, edit, and collaborate on collaboration content items at the same time or at different times. In some embodiments, this can be managed by requiring two users access a content item through a web interface and there they can work on the same copy of the content item at the same time.

Collaboration Companion Interface

In some embodiments, client collaboration service 160 can provide a native application companion interface for the purpose of displaying information relevant to a content item being presented on client device 150. In embodiments wherein a content item is accessed by a native application stored and executed on client device 150, where the content item is in a designated location of the file system of client device 150 such that the content item is managed by content application 152, the native application may not provide any native way to display the above addressed collaboration data. In such embodiments, client collaboration service 160 can detect that a user has opened a content item, and can provide an overlay with additional information for the content item, such as collaboration data. For example, the additional information can include comments for the content item, status of the content item, sharing of other users previously or currently viewing the content item. Such an overlay can warn a user that changes might be lost because another user is currently editing the content item.

In some embodiments, one or more of the services or storages/databases discussed above can be accessed using public or private application programming interfaces.

Certain software applications can access content storage 142 via an API on behalf of a user. For example, a software package such as an application running on client device 150, can programmatically make API calls directly to content management system 110 when a user provides authentication credentials, to read, write, create, delete, share, or otherwise manipulate content.

A user can view or manipulate content stored in a user account via a web interface generated and served by web interface service 124. For example, the user can navigate in a web browser to a web address provided by content management system 110. Changes or updates to content in the content storage 142 made through the web interface, such as uploading a new version of a content item, can be propagated back to other client devices associated with the user's account. For example, multiple client devices, each with their own client software, can be associated with a single account and content items in the account can be synchronized between each of the multiple client devices.

Client device 150 can connect to content management system 110 on behalf of a user. A user can directly interact with client device 150, for example when client device 150 is a desktop or laptop computer, phone, television, internet-of-things device, etc. Alternatively or additionally, client device 150 can act on behalf of the user without the user having physical access to client device 150, for example when client device 150 is a server.

Some features of client device 150 are enabled by an application installed on client device 150. In some embodiments, the application can include a content management system specific component. For example, the content management system specific component can be a stand-alone application 152, one or more application plug-ins, and/or a browser extension. However, the user can also interact with content management system 110 via a third-party application, such as a web browser, that resides on client device 150 and is configured to communicate with content management system 110. In various implementations, the client-side application 152 can present a user interface (UI) for a user to interact with content management system 110. For example, the user can interact with the content management system 110 via a file system explorer integrated with the file system or via a webpage displayed using a web browser application.

In some embodiments, client application 152 can be configured to manage and synchronize content for more than one account of content management system 110. In such embodiments client application 152 can remain logged into multiple accounts and provide normal services for the multiple accounts. In some embodiments, each account can appear as folder in a file system, and all content items within that folder can be synchronized with content management system 110. In some embodiments, client application 152 can include a selector to choose one of the multiple accounts to be the primary account or default account.

While content management system 110 is presented with specific components, it should be understood by one skilled in the art, that the architectural configuration of system 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

In some embodiments, content management system 110 can interact with one or more third party services 190 to carry out additional functions.

While system 100 is presented with specific components, it should be understood by one skilled in the art, that the architectural configuration of system 100 is simply one possible configuration and that other configurations with more or fewer components are possible.

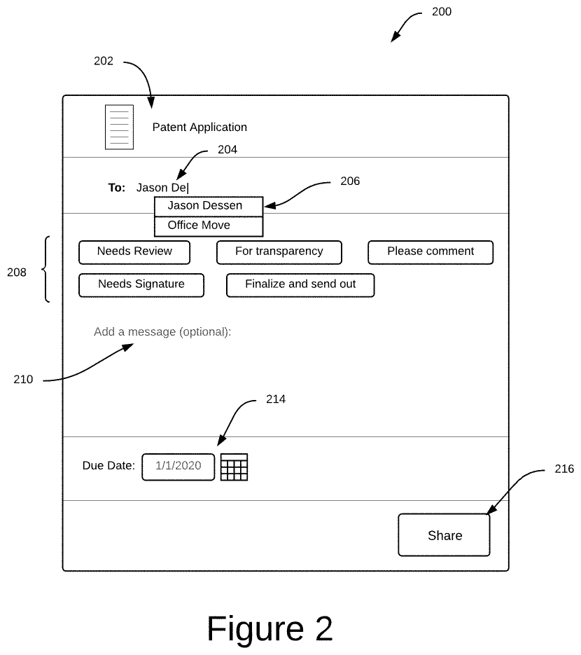

FIG. 2 illustrates an example sharing modal 200. Sharing modal can be presented by sharing service 128 either in web browser through web interface service 124 or through client application 152. Sharing modal 200 is a user interface designed to encourage a first user that is sharing a content item to provide useful contextual information.

Sharing modal 200 can include content item field 202 to identify a content item that is to be shared. The content item can become identified in sharing modal 200 when the content item is selected for sharing in content item field 202.

Sharing modal 200 also includes recipient field 204 for identifying at least one target user account with which to share content item 202. In some embodiments, one or more individual user accounts and/or a team name representing a plurality of target user accounts can be identified in recipient field 204. In some embodiments, as a first user types a recipient name into recipient field 204, sharing modal 200 can provide a dynamic picklist 206 showing contacts matching the typed characters to a recipient name, including teams that include the typed recipient name. For example, as illustrated in FIG. 2, picklist 206 is shown including the selectable options “Jason Dessen” and “Office Move.” The option “Jason Dessen” matches the characters typed thus far in recipient field 204, while the option “Office Move” is provided because a user account with the name “Jason Dessen” is included in the team “Office Move.”

Sharing modal 200 can also include selectable status flags 208. Status flags 208 can be selected by the first user and identify a general status associated with the sharing of the content item. For example, as illustrated in FIG. 2 some status flags include “needs review”, “for transparency”, “please comment”, “needs signature”, and “finalize and send out”.

In some embodiments, content management system 110 can also include classifiers that are configured to automatically determine and apply a status flag 208 based on other information received in the sharing modal or sharing communication.

If the first user is willing to provide more specific context, sharing modal 200 includes message field 210. The first user can use message field 210 to @ mention a specific user account. This can be useful when the content item is shared with an entire team but the first user wants to gain the specific attention of a subset of user accounts. In some embodiments, messages that @ mention a specific user account may only be sent to that user account even if the content item is shared with a larger group of user accounts.

Message field 210 can also be used to tag a content item to a particular project such as a codename identifying a project. The first user can also provide any additional context in message field 210.

Sharing modal 200 can also include date picker 214 to encourage the first user to select a due date by which any specific action or status needs to be completed or updated.

All of the information entered into sharing modal 200 can be stored in metadata database 146 in association with content item 202. In this way, the contextual data gathered in sharing modal 200 can remain associated with content item 202 whenever it is viewed in content management system 110 and the contextual data can accompany content item 202 whenever it is shared in third-party service 190 by content management system 110.

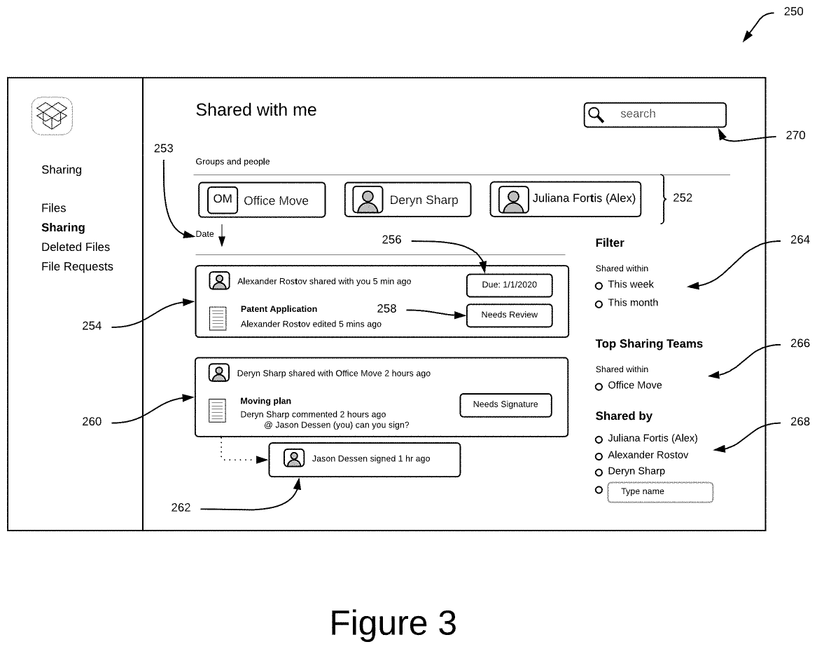

FIG. 3 illustrates sharing interface 250. Sharing interface 250 is an interface that can be viewed by any target user account that is the recipient of a shared content item. Sharing interface 250 can present contextual information regarding any content item that has been shared with the target user account, including any shared content item in content management system 110 or in third party service 190. For example, as illustrated in FIG. 3, sharing interface 250 shows contextual information 254 regarding content item called “patent application” and contextual information 260 regarding content item “moving plan”.

Each of contextual information 254 and contextual information 260 includes information regarding a user account that shared the content item, how long ago the content item was shared, status flags 258, and most recent status information pertaining to the respective content item. In some embodiments, as seen associated with contextual information 254 a due date 256 can be presented.

Contextual information 254 shows that Alexander Rostov shared content item “patent application” with the target user five minutes ago and further shows that the content item “patent application” was last edited by Alexander Rostov five minutes ago. Contextual information 254 further shows that the reason the content item “patent application” was shared is that it needs review as indicated by status like 258 and that the due date 256 for the call to action indicated by status flag 258 is Jan. 1, 2020.

Contextual information 260 shows that Deryn Sharp shared the content item “moving plan” with the group “office move” two hours ago and that Deryn Sharp asked the target user (Jason Dessen) to sign the content item “moving plan” and included status flag 258 with a call to action indicating that a signature is needed.

In some embodiments, supplemental contextual information 262 can be displayed. For example, supplemental contextual information 262 can be displayed in association with contextual information 260. Supplemental information 262 can provide information regarding the particular call to action reflected by the status flag “needs signature”. Supplemental information 262 is a completion notification indicating that the target user has performed the action that was requested—in this case the target user (Jason Dessen) has signed the document as requested.

Sharing interface 250 further includes options for sorting, filtering, and searching for shared content items and associated context. As illustrated in FIG. 3, sharing interface 250 presents selectable objects representing sharing entities 252 (user accounts and teams). Sharing entities 252 can include entities in which content items have been shared from or to when the content items have also been shared with the particular target user viewing sharing interface 250. In some embodiments, sharing interface 250 can order sharing entities 252 according to entities associated with content items that were either most recently shared or most recently interacted with.

Sharing interface 250 also includes a selectable option to sort by date 253. In some embodiments, the date by which content in sharing interface 250 is sorted by is the day in which a content item was shared or the date in which the content item was last interacted with.

Further sharing interface 250 includes a filter 264 to filter for content items shared within a particular time.

Another filter provided by sharing interface 250 is to filter according to top sharing teams 266. In the example shown in FIG. 3, the only sharing team is the team “office move” but if other teams shared content with the target user they would also appear here. Sharing interface 250 also provides a filter to filter according to a particular user account that has shared a content item. Filter 268 presents user accounts that have most recently shared a content item and a search box to search for other user accounts not listed here.

Finally, sharing interface 250 also provides an open search field 270 to search for shared content items.

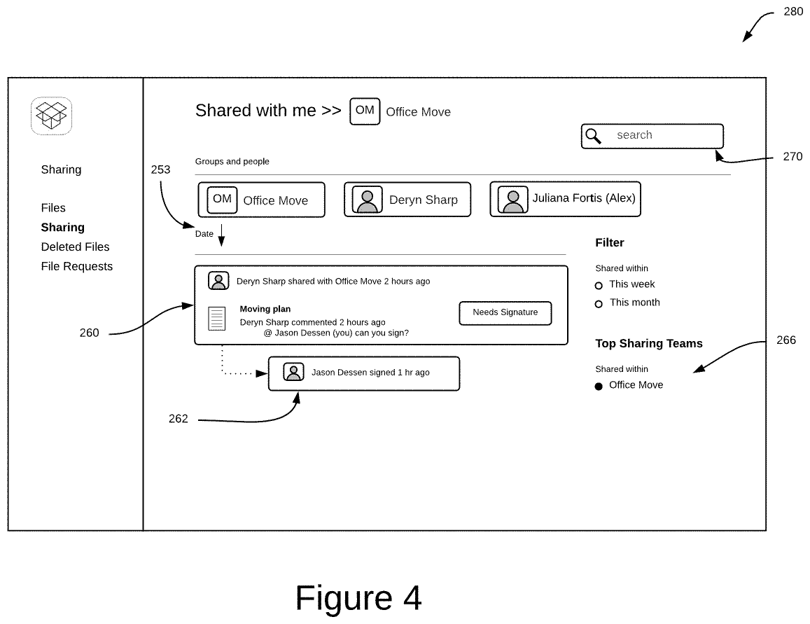

FIG. 4 illustrates an example of sharing interface 250 when a filter for the team “office move” 266 has been selected. Thus, in FIG. 4 only contextual information 260 and supplemental contextual information 262 are shown if they pertain to content that was shared with team “office move.”

In some embodiments, sharing interface 280 can itself be an interface for receiving additional context that is not directly tied to taking an action on the content item. For example, a user in a group that is sharing content item can make a general comment to the group of user accounts having shared access to the content item and this content can be displayed.

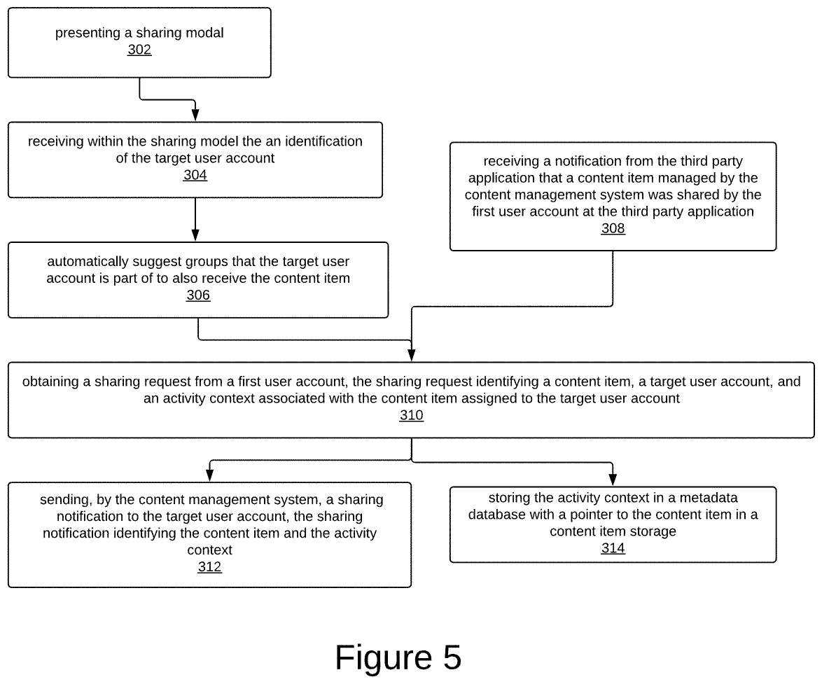

FIG. 5 illustrates an example method for receiving and storing sharing context associated with the content item. In some embodiments, and as illustrated in FIG. 2, sharing service 128 can present (302) a sharing modal, which can receive (304) identification of at least one target user account, and can automatically suggest (306) groups that the target user account is part of to receive the content item.

In some embodiments, the content item may be shared outside of content management system 110, for example through third-party service 190. Examples of third party services 190 can be any services that are useful for sharing a content item with a message providing some context to why the content item is being shared. For example, a first user account can send an email to a target user account that includes a content item and a message. In another example, a first user account can send a message using a messaging service (like instant messaging) or a team based communication services (like SLACK or WEBEX TEAMS) that can include a content item and a message pertaining to why the content item is being shared. In another example, a first user can assign tasks in a workflow service and send a content item along with the task. However, in the present technology, the third party service 190 is linked to content management system 110 such that third party service 190 can inform content management system 110 when a content item under management of content management system 110 has been shared.

Third party service 190 can be linked to content management system 110 via an application programming interface(s) provided by content management system 110 or third party service 190. In some embodiments, third party service can determine that a content item is managed by content management system 110 when the content item includes a link, pointer, or reference to content management system either as its method of being shared, or in its metadata. When third party service 190 detects a content item that is managed by content management system 110, third party service 190 can send and content management system 110 can receive (308) a communication notifying content management system 110 that a content item it manages has been shared via third party service 190. In some embodiments, third party service 190 can also send any message that the content item was shared with.

In some embodiments, content management system 110 can be granted access to a user account at third party service 190 when the user account at content management system 110 provides credentials to the user account at third party service 190. With this type of access, content management system 110 can monitor the user account at third party service 190 to determine messages sent in relation to content items under management of content management system 110 and to determine to whom the content item is shared with at third party service 190.

Whether through a sharing modal, such as sharing modal 200, or through third-party service 190, sharing service 128 of content management system 110 can obtain (310) a sharing request from the first user account. The sharing request can identify a content item to be shared, a target user account to receive the shared content item, and sharing context associated with the content item.

Sharing service 128 can then give any target users access to the content item in access control list 145 and can store (314) the sharing context in metadata database 146 with a pointer to the content item. Additionally, sharing service 128 can send (312) a sharing notification to the target user's account. The sharing notification can at least identify the content item and the sharing context. The sharing context can include information such as is displayed in contextual information 254, 260, including a first user that shared the content item, a due date, a status flag, a message associated with the sharing, etc.

In some embodiments, the sharing request can address a plurality of user accounts, or the content item can have previously been shared with a plurality of user accounts, but the sharing request addresses specific context to a subset of user accounts. In such embodiments, any specific context that is addressed only to a subset of user accounts can be sent to those user accounts only, rather than a larger group for which may have been granted access to the shared content item. The sharing notification can be sent to each user account which has received access to the content item, but only the sharing notifications that are sent to the subset of user accounts for which the context is addressed will identify the sharing context.

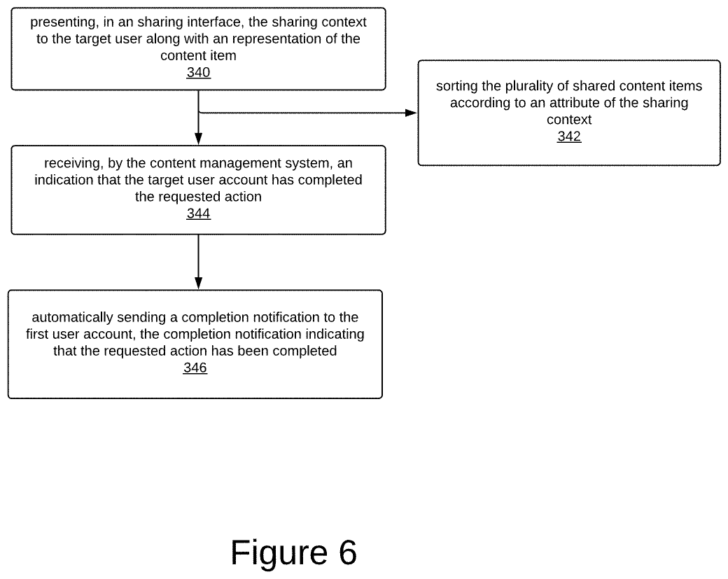

FIG. 6 illustrates an example method embodiment for presenting shared content items along with sharing context. Sharing service 128 can present (340) a sharing interface 250 showing sharing context to a target user along with a representation of the content item. In some embodiments, sharing interface 250 can be used to sort (342) or filter the plurality of shared content items according to an attribute of the sharing context.

The content item represented in sharing interface 250 can be selected by a user operating a user interface device and opened.

In some embodiments, the target user may complete the requested action and the target user can notify other user accounts to which the content item is shared by replying to the notification in sharing interface 250 that contains the sharing context. Sharing service 128 of content management system 110 can receive (344) an indication from the target user that the target user account has completed the requested action and can automatically send (346) a completion notification to the first user account. The completion notification can indicate that the requested action has been completed. The completion notification can be presented in the sharing interface 250 of the first user and the target user as supplemental context.

As noted above, in some embodiments, the sharing request can occur at third party service 190. Sometimes these sharing requests can identify a plurality of target user accounts. In such embodiments, content management system 110 might determine that the plurality of target accounts should be identified as a team at content management system 110. Content management system 110 can identify user accounts at content management system 110 that correspond to user accounts at third party service 190 and instruct team service 130 to create a team with these user accounts. In some embodiments, content management system 110 can suggest the creation of a team prior to automatically creating the team.

In some embodiments, content management system 110 can also send sharing messages that originate at content management system 110 at third party service 190 so that context created at content management system 110 is reflected at third party service 190.

In some embodiments, context associated with a content item can also be used by content management system 110 to more intelligently carry out various functions with respect to the content item. One such function could be making the content item more easily accessible to a user. For example, content management system could recognize that the context associated with a content item specifies that a particular user account needs to take action on the content item. Content management system 110 could then make the content item sort to the top of a content item browsing interface so that the content item is easy to find. Content management system 110 could also make sure that the content item is locally available on a user account's client device 150. As addressed above, content management system 110 can synchronize content items with client device 150, and in some embodiments, only a subset of all content items synchronize to client device 150 to save storage space on client device 150. Using the present technology, content management system 110 can selectively synchronize content items to client device 150 when the content item is associated with a context indicating that the user account needs to take action on the content item.

While most of the description provided herein addresses context created when a content item is shared or acted upon, content can be created absent any action on a content item. The sharing of a content item can result in a sharing group being created. Once a sharing group is created, the present technology can also provide for messages to be sent among the user accounts that are members of the group without requiring any action on a content item.

In some embodiments, context can be stored in metadata database 146 in association with a sharing group identifier in addition to (or as an alternative to) a content item identifier. Thereby when an interface like sharing interface 280, which is specific to a group (Office Move) is displayed all context shared between the group can be presented. In this way, sharing interface 280 can also function as a workspace capturing all other context that is not directly associated with a shared content item. Just as with other embodiments above, the context that is shared amongst the group can originate in third party service 190.

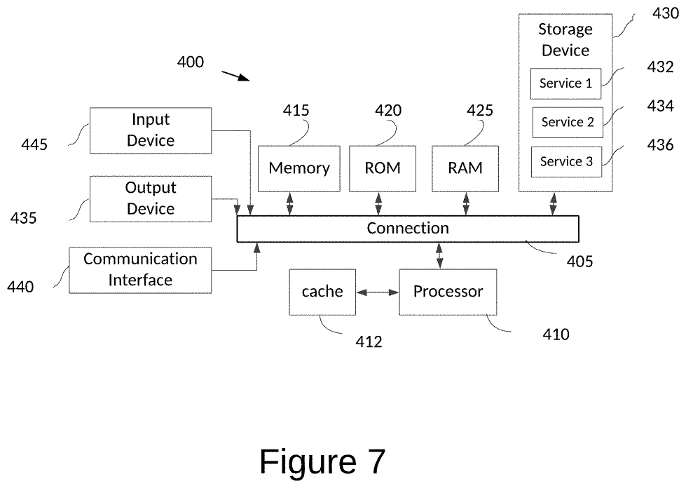

FIG. 7 shows an example of computing system 400, which can be for example any computing device making up client device 150, content management system 110 or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments, computing system 400 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a content management system, a sharing request from a first user account of the content management system, the sharing request identifying a content item stored at the content management system, a target user account at the content management system, and a sharing context associated with the content item assigned to the target user account;
sending, by the content management system, a sharing notification to the target user account, the sharing notification identifying at least the content item and the sharing context without including the content item; and
providing, in a sharing interface of the content management system, the sharing context to be presented to the target user account along with a representation of the content item, wherein the sharing context is stored at the content management system and correlated to the content item.

2. The method of claim 1, wherein the sharing context indicates a requested action to be completed by the target user account, the method further comprising:
receiving, by the content management system, an indication that the target user account has completed the requested action; and
automatically sending, by the content management system, a completion notification to the first user account, the completion notification indicating that the requested action has been completed.

3. The method of claim 1, wherein the sharing request identifies a plurality of target user accounts and the sharing context is assigned only to a subset of the target user accounts, the method further comprising:
sending the sharing notification to each user account in the plurality of target user accounts, wherein only those sharing notifications that are sent to the subset of user accounts identify the sharing context.

4. The method of claim 1, further comprising:
storing the sharing context in a metadata database with a pointer to the content item in a content item storage.

5. The method of claim 1, wherein the sharing interface provides representations of a plurality of shared content items along with a respective associated sharing context, the method further comprising:
sorting the plurality of shared content items according to an attribute of the respective associated sharing context.

6. The method of claim 1, wherein the providing the sharing context includes providing a note regarding a requested action and a status flag.

7. The method of claim 1 wherein the sharing request originates from a third party application, the method further comprising:
receiving by the content management system a notification from the third party application that the content item was shared by the first user account at the third party application, the notification including an identifier for the target user account, an identifier of the content item, and a message sent with the content item.

8. The method of claim 7, further comprising:
in addition to the notification including the identifier of the target user account, the notification including identifiers for a plurality of user accounts at the third party application;
determining that at least some of the plurality of user accounts at the third party application correspond to respective user accounts at the content management system; and
automatically creating a sharing group at the content management system.

9. The method of claim 1, further comprising:
providing, to the first user account, a sharing modal prior to the receiving of the sharing request;
receiving within the sharing modal an identification of the target user account; and
automatically suggesting groups with the sharing modal to receive the content item, the target user account being associated with the suggested groups.

10. A non-transitory computer readable medium comprising instructions stored thereon, the instructions, when executed, cause at least one processor to:
receive, by a content management system, a sharing request from a first user account of the content management system, the sharing request identifying a content item stored at the content management system, a target user account at the content management system, and a sharing context associated with the content item assigned to the target user account;
send, by the content management system, a sharing notification to the target user account, the sharing notification identifying at least the content item and the sharing context without including the content item; and
provide, in a sharing interface of the content management system, the sharing context to be presented to the target user account along with a representation of the content item, wherein the sharing context is stored at the content management system and correlated to the content item.

11. The non-transitory computer readable medium of claim 10, wherein the sharing context indicates a requested action to be completed by the target user account, the instructions further causing the at least one processor to:
receive, by the content management system, an indication that the target user account has completed the requested action; and
automatically send, by the content management system, a completion notification to the first user account, the completion notification indicating that the requested action has been completed.

12. The non-transitory computer readable medium of claim 10, wherein the sharing request identifies a plurality of target user accounts and the sharing context is assigned only to a subset of the target user accounts, the instructions further causing the at least one processor to:
send the sharing notification to each user account in the plurality of target user accounts, wherein only those sharing notifications that are sent to the subset of user accounts identify the sharing context.

13. The non-transitory computer readable medium of claim 10, wherein the instructions further cause the at least one processor to:
store the sharing context in a metadata database with a pointer to the content item in a content item storage.

14. The non-transitory computer readable medium of claim 10, wherein the sharing interface provides representations of a plurality of shared content items along with a respective associated sharing context, the instructions further causing the at least one processor to:
sort the plurality of shared content items according to an attribute of the respective associated sharing context.

15. The non-transitory computer readable medium of claim 10, wherein the providing the sharing context includes providing a note regarding a requested action, and a status flag.

16. The non-transitory computer readable medium of claim 10, wherein the sharing request originates from a third party application, the instructions further causing the at least one processor to:
receive by the content management system a notification from the third party application that the content item was shared by the first user account at the third party application, the notification including an identifier for the target user account, an identifier of the content item, and a message sent with the content item.

17. The non-transitory computer readable medium of claim 16 wherein in addition to the notification including the identifier of the target user account, the notification including identifiers for a plurality of user accounts at the third party application, the instructions further causing the at least one processor to:
determine that at least some of the plurality of user accounts at the third party application correspond to respective user accounts at the content management system; and
automatically create a sharing group at the content management system.

18. The non-transitory computer readable medium of claim 10 wherein the instructions further cause the at least one processor to:
providing, to the first user account, a sharing modal prior to the receiving of the sharing request;
receive within the sharing modal an identification of the target user account; and
automatically suggest groups with the sharing modal to receive the content item, the target user account being associated with the suggested groups.

19. A system comprising:
a non-transitory computer readable medium comprising instructions stored thereon;
at least one processor configured to execute the instructions, which, when executed, cause the at least one processor to:
receive, by a content management system, a sharing request from a first user account of the content management system, the sharing request identifying a content item stored at the content management system, a target user account at the content management system, and a sharing context associated with the content item assigned to the target user account;
send, by the content management system, a sharing notification to the target user account, the sharing notification identifying at least the content item and the sharing context without including the content item; and
provide, in a sharing interface of the content management system, the sharing context to be presented to the target user account along with a representation of the content item, wherein the sharing context is stored at the content management system and correlated to the content item.

20. The system of claim 19, wherein the instructions further cause the at least one processor to:
store the sharing context in a metadata database with a pointer to the content item in a content item storage.
